(19) United States
(12) Patent Application Publication
(10) Pub. No.: US 2006/0099293 A1
(43) Pub. Date: May 11, 2006

(54) Molding apparatus

(76) Inventors: James O. Adas, Clinton Township, MI (US); Douglas A. Miller, Pierson, MI (US)

Correspondence Address: MILACRON INC., 2090 FLORENCE AVE., CINCINNATI, OH, 45206, US

(21) Appl. No.: 10/985,234

(22) Filed: Nov. 10, 2004

(51) Int. Cl. B29C 35/00

(52) U.S. Cl. 425/444

(57) ABSTRACT

A mold assembly comprises a sub-assembly for retaining a mold component, the sub-assembly having an ejector box being open to a side of the sub-assembly accessible through an opening of a molding machine as the sub-assembly is mounted in the molding machine, a cover movably mounted to the sub-assembly on the exposed side thereof to be movable between an open position providing access to the interior of the ejector box and a closed position substantially covering the ejector box; and at least one fastener attached to one of the cover and sub-assembly for releasably retaining the cover in the closed position. The mold assembly advantageously comprises a hinge having a fixed element attached to the sub-assembly and a rotatable element attached to the cover, whereby the cover is rotatable between the open position and the closed position.

### BACKGROUND OF THE INVENTION

1. Field of the Invention

This invention relates generally to molding. In particular, this invention relates to mold assemblies having ejector devices.

2. Description of Related Art

It is known in the art of molding, for example injection molding, to use mold assemblies comprising mating mold components defining one or more mold cavities together with mounting sub-assemblies constructed for mounting to members of a molding machine. In addition to the mating mold components, mold assemblies advantageously comprise ejector devices for dislodging molded material from the mating mold components. It is known to provide mounting sub-assemblies that include elements of an ejector device within an aperture therein. The aperture of a mounting sub-assembly containing elements of the ejector device is known as an “ejector box” and the ejector box is advantageously open on a side of the sub-assembly left exposed or accessible through openings in the machine as the sub-assembly is mounted to a machine member. Hence, with the sub-assembly installed in a molding machine press, access is provided from the accessible side to the ejector devices. It is known to provide a cover for the accessible side of the ejector box. Known ejector box covers are attached to the sub-assembly by fasteners requiring removal of at least the fasteners or components of the fasteners to provide access to the interior of the ejector box. Consequently a disadvantage of known ejector box covers is the need for removal of at least some fasteners or components thereof to provide access to the ejector box interior.

### SUMMARY OF THE INVENTION

It is an object of the present invention to provide a mold assembly comprising a sub-assembly for retaining a mold component wherein a cover is releasably retained in a position covering an ejector device aperture by fastening means, the operable components of which are attached to and retained by at least one of the mold component and the ejector box cover.

It is a further object of the present invention to provide a mold assembly comprising a sub-assembly for retaining a mold component, the sub-assembly having an ejector box being open to a side of the sub-assembly accessible through an opening in a molding machine as the sub-assembly is mounted in the molding machine; a cover mounted to the sub-assembly to be movable between an open position providing access to the interior of the ejector box and a closed position substantially covering the ejector box; and at least one fastener the operable components of which are attached to one of the cover and sub-assembly for releasably retaining the cover in the closed position.

Further objects and advantages of the invention shall be made apparent from the accompanying drawings and the following description thereof.

In accordance with the aforesaid objects the present invention provides a mold assembly comprising a sub-assembly for retaining a mold component, the sub-assembly having an aperture therein wherein elements of an ejector device are contained, the aperture being open to a side of the sub-assembly accessible through an opening in a molding machine as the sub-assembly is mounted in the molding machine; a cover movably mounted to the sub-assembly on said accessible side thereof, the cover being movable between an open position providing access to the interior of the aperture and a closed position substantially covering the aperture; and, at least one fastener, the operable components of which are attached to one of the cover and sub-assembly for releasably retaining the cover in the closed position. Advantageously, a fastener component is attached to the cover and engages the sub-assembly so as to releasably retain the cover in a closed position.

### BRIEF DESCRIPTION OF THE DRAWINGS

FIG. 1 is a three dimensional view of a mold sub-assembly having an ejector box.

FIG. 2 shows the sub-assembly of FIG. 1 with a cover in a closed position covering the ejector box.

FIG. 3 shows the sub-assembly of FIG. 1 with a cover in an open position providing access to the interior of the ejector box.

### DETAILED DESCRIPTION OF THE PREFERRED EMBODIMENT

The invention shall be illustrated with reference to a preferred embodiment which shall be described in detail. It is not the intention of applicants that the invention be limited to the preferred embodiment, but rather that the invention shall be defined by the appended claims and all equivalents thereof.

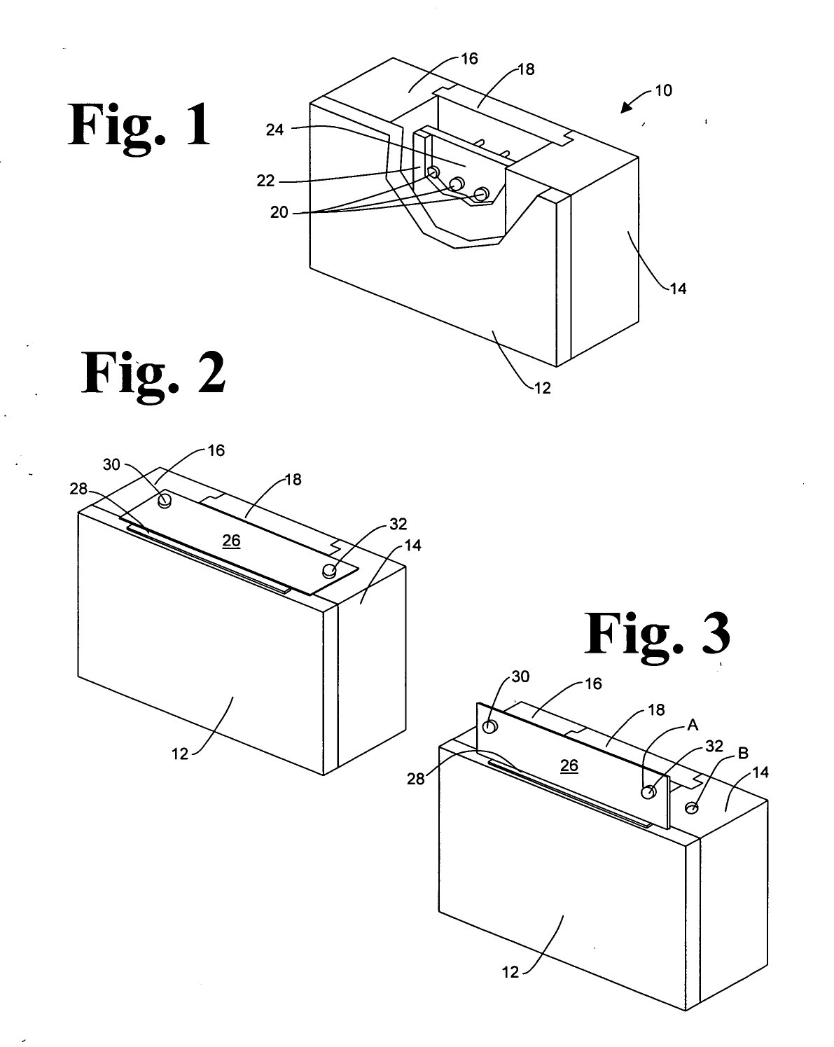

Referring to FIG. 1, a mold sub-assembly 10 comprises a mounting plate 12, right and left side die retention plates 14 and 16, respectively, and a die mounting plate 18 for supporting a mold component. As shown, left and right side die retention plates space die mounting plate 18 from mounting plate 12. Advantageously, left and right side retention plates have grooves for receiving projecting ears of die mounting plate 18 facilitating removal and insertion of die mounting plates with mold components attached. Elements of an ejector device are movably supported within the aperture created by mounting plate 12, die retention plates 14 and 16 and die mounting plate 18, the ejector device aperture referred to herein as an “ejector box”. Ejector device elements within the ejector box comprise ejector pins 20, ejector plate 24 for supporting ejector pins 20 and pin retainer plate 22 for retaining ejector pins 20 on ejector plate 24. Ends of ejector pins 20 pass through die mounting plate 18 and protrude into a mold component mounted thereto. Movement of ejector plate 24 toward die mounting plate 18 advances the projecting ends of ejector pins 20 to dislodge a molded article and sprue from the mold component mounted thereon.

Referring to FIGS. 2 and 3, a cover, such as cover 26, is provided on the side of sub-assembly 10 which is accessible through an opening of the press section of a molding machine as sub-assembly 10 is mounted in the molding machine. Cover 26 is mounted to mounting plate 12 by hinge 28. As shown in FIG. 2, when in the “closed” position, cover 26 substantially covers the top of the ejector box. As seen in FIG. 3, when cover 26 is in the “open” position, access is had to the interior of the ejector box and hence to ejector pins 20, ejector plate 24 and pin retainer 22. Fastening means, such as fasteners 30 and 32 releasably retain cover 26 in the closed position by releasable attachment to die retention plates 16 and 14 respectively. Hinge 28 comprises at least one fixed element attached to mounting plate 18 and at least one rotating element attached to cover 26 permitting rotation of cover 26 relative to mounting plate 18 between the open and closed positions.

Fasteners 30 and 32 comprise operable components attached to at least one of cover 26 and die retention plates 16 and 14. As illustrated in FIG. 3 components “A” and “B” of fastener 32 are retained by, respectively, cover 26 and die retention plate 14 to which they are attached when the fastener components are not engaged, as illustrated with the cover in the “open” position. Suitable fasteners for such an arrangement are of the rotating cam-action type wherein the rotating components are retained by cover 26 and the cam engaging components are attached to or comprise each of die retention plates 16 and 14. For such fasteners, the “B” operable component comprising die retention plates 14 and 16 may be blind holes undercut to produce a lip engaged by rotating “A” components attached to and retained by cover 26. Alternatively, fasteners 30 and 32 could comprise captive threaded members (such as nuts or bolts), one member of each fastener being retained by cover 26 and the other member of each fastener being retained by die retention plates 16 and 14. For such fasteners, the “B” components may be threaded bores comprising die retention plates 14 and 16 or threaded nuts attached to die retention plates 14 and 16, the “B” components being engagable by threaded “A” components such as captive bolts attached to and retained by cover 26. Further, fasteners 30 and 32 could as well be capture type fasteners having movable components retained by die retention plates 16 and 14 to releasably “capture” cover 26 when in the “closed” position. Each capture type fastener including a sliding or rotating component that is movable between positions that engage cover 26 and that clear cover 26 to permit rotation of cover 26 at hinge 28. Irrespective of the particular fastening means chosen, components of fasteners 30 and 32 operate to releasably retain cover 26 in the closed position and permit release of cover 26 and movement thereof to an open position without removal of the components of the fastening means attached respectively to sub-assembly 10 or cover 26.

What is claimed is:

1. A mold assembly comprising:
a) a sub-assembly for retaining a mold component, the sub-assembly having an aperture therein wherein elements of an ejector device are contained, the aperture being open to a side of the sub-assembly accessible through an opening of a molding machine as the sub-assembly is mounted in the molding machine;
b) a cover movably mounted to the sub-assembly on said accessible side thereof, the cover being movable between an open position providing access to the interior of the aperture and a closed position substantially covering the aperture; and,
c) at least one fastening means, operable components of which are attached to and retained by at least one of the cover and sub-assembly for releasably retaining the cover in the closed position.

2. The mold assembly according to claim 1 wherein each fastener means comprises an operable component attached to and retained by the cover and engagable with a component comprising the sub-assembly so as to releasably retain the cover in a closed position.

3. The mold assembly according to claim 1 wherein each fastener means comprises an operable component attached to the sub-assembly for engaging the cover so as to releasably retain the cover in a closed position.

4. The mold assembly according to claim 1 wherein each fastener means comprises an operable component attached to and retained by the cover and engagable with a component attached to and retained by the sub-assembly so as to releasably retain the cover in a closed position.

5. The mold assembly according to claim 1 further comprising a hinge having at least one fixed element attached to the sub-assembly and at least one rotatable element attached to the cover, whereby the cover is rotatable between the open position and the closed position.

6. A mold assembly comprising:
a) a sub-assembly for retaining a mold component, the sub-assembly having an ejector box therein wherein elements of an ejector device are movably supported by the sub-assembly, the ejector box being open to a side of the sub-assembly accessible through an opening in a molding machine as the sub-assembly is mounted in the molding machine;
b) a cover movably mounted to the sub-assembly on said accessible side thereof;
c) a hinge having at least one fixed element attached to the sub-assembly and at least one rotatable element attached to the cover, whereby the cover is rotatable between an open position providing access to the interior of the ejector box and a closed position substantially covering the ejector box; and,
d) at least one fastening means, operable components of the fastening means being attached to and retained by at least one of the cover and sub-assembly for releasably retaining the cover in the closed position.

7. The mold assembly according to claim 6 wherein each fastening means comprises an operable component attached to and retained by the cover and engagable with an operable component comprising the sub-assembly so as to releasably retain the cover in a closed position.

8. The mold assembly according to claim 6 wherein each fastener means comprises an operable component attached to the sub-assembly for engaging the cover so as to releasably retain the cover in a closed position.

9. The mold assembly according to claim 6 wherein each fastener means comprises an operable component attached to and retained by the cover and engagable with a component attached to and retained by the sub-assembly so as to releasably retain the cover in a closed position.
